(19) United States
(12) Patent Application Publication
(10) Pub. No.: US 2022/0050954 A1
(43) Pub. Date: Feb. 17, 2022

(54) CONTROLLER AND NON-TRANSITORY COMPUTER READABLE MEDIUM

(71) Applicant: FUJIFILM BUSINESS INNOVATION CORP., Tokyo (JP)

(72) Inventors: Shotaro MISAWA, Kanagawa (JP); Tomoko OHKUMA, Kanagawa (JP)

(73) Assignee: FUJIFILM BUSINESS INNOVATION CORP., Tokyo (JP)

(21) Appl. No.: 17/177,753

(22) Filed: Feb. 17, 2021

(30) Foreign Application Priority Data
Aug. 12, 2020 (JP) 2020-136476

(51) Int. Cl. G06F 40/166; G06T 11/60; G06K 9/00; G06F 3/0484

(52) U.S. Cl. CPC G06F 40/166; G06T 11/60; G06T 2200/24; G06F 3/04842; G06K 9/00335

(57) ABSTRACT

A controller includes a processor configured to receive an attribute of a device that a user uses, and control, in accordance with the attribute of the device, a representation of association text such that, by selecting a representation of association text out of a plurality of representations of association text and displaying the selected representation of association text, motivation of the user of a behavior performed for an object displayed in a display region of the device is increased, the association text being associated with the object displayed in the display region of the device.

### CROSS-REFERENCE TO RELATED APPLICATIONS

This application is based on and claims priority under 35 USC 119 from Japanese Patent Application No. 2020-136476 filed Aug. 12, 2020.

### BACKGROUND

### (i) Technical Field

The present disclosure relates to a controller and a non-transitory computer readable medium.

### (ii) Related Art

A character display method for displaying a document including a plurality of types of characters on an information terminal is disclosed in Japanese Unexamined Patent Application Publication No. 2005-228016. In the character display method, a predetermined type of character specified from among a plurality of types of characters is stored in advance in a memory device, characters of the predetermined type of character are extracted from the document, a character representing characteristics of the document is identified from among the extracted characters, and the identified character is displayed in a predetermined arrangement.

A display device that includes control means for performing control such that character regions of image data are displayed on display means in a partial region display mode in which character regions are displayed at display magnifications determined based on widths of the character regions in image data is disclosed in Japanese Unexamined Patent Application Publication No. 2015-106289. In a case where a character region of body text is displayed as a display target in the partial region display mode, the control means determines a display magnification such that the width of the character region of the body text as the display target falls within the width of a display region of the display means, and performs control such that the character region of the body text as the display target is displayed at the determined display magnification. In a case where a character region of small-sized text including characters of a smaller size than those of the body text is displayed as a display target in the partial region display mode, the control means further determines whether or not the width of the character region of the small-sized text as the display target is smaller than the largest width of a character region of the body text in the image data. In a case where it is determined that the width of the character region of the small-sized text is smaller than the largest width of the character region of the body text, the control means determines a display magnification such that the largest width of the character region of the body text falls within the width of the display region of the display means and displays the character region of the small-sized text as the display target at the determined display magnification. In the case where it is determined that the width of the character region of the small-sized text is not smaller than the largest width of the character region of the body text, the control means determines a display magnification such that the width of the character region of the small-sized text falls within the width of the display region of the display means and displays the character region of the small-sized text as the display target at the determined display magnification.

A method for personalizing an image display electronic device that includes at least one display parameter for a variable value is disclosed in Japanese Translation of PCT Application Publication No. 2016-526197. The image display electronic device is suitable for displaying an image and for correcting the displayed image in accordance with the value of the display parameter. The method causing the value of the display parameter to be suitable for a user, includes a step of connecting the image display electronic device to a user database, determining at least one value of a parameter for evaluating a vision and eye movements profile of the user, and recording the determined at least one value into the user database, the at least one value including a measurement value of the vision of the user, a step of connecting the image display electronic device to a display database and creating, within the display database, digital records including a plurality of display parameter values associated with the image display electronic device and an identifier of the image display electronic device, the digital records being stored in a register of the display database including a plurality of digital records associated with a plurality of image display electronic devices, a record of each of the image display electronic devices in the register being associated with a single identifier, a step of selecting, regarding viewing by the user of an image displayed on the image display electronic device, an optimal display parameter value from among the plurality of display parameter values of the digital records associated with the image display electronic devices within the display database in accordance with the vision measurement value associated with the user within the user database, and automatically applying the optimal image display parameter value to the image display electronic device so that recognition and readability of the displayed image and visual comfortability of the user are improved.

### SUMMARY

Output devices that output, based on text describing an object (hereinafter, referred to as “description text”), text associated with the object (hereinafter, referred to as “association text”) have been known.

For example, in a case where an object is a product, description text is a description sentence describing the outline of the product, and association text is a catch phrase for the product, the catch phrase output from an output device may be, for example, posted on a website introducing the product, so that the motivation of a user for buying the product may be increased.

Meanwhile, a device to be used by a user to view a website is not limited to a specific type. For example, some users may view a website on a 20-inch or larger display of a desktop computer or may view a website on a smartphone with a size of about 6 inches.

Depending on the attribute of a device that a user uses, for example, the size of a screen on which association text is displayed, the page design of a website, and operability of the device vary. Thus, even with association text for the same object, representation of association text that draws more attention of a user may vary according to the attribute of a device. However, a technique for controlling representation of association text taking into consideration variations in the representation of association text that draws more attention of a user according to the attribute of a device has not been suggested.

Aspects of non-limiting embodiments of the present disclosure relate to providing a controller and a non-transitory computer readable medium that control representation of association text to draw attention of a user, compared to a case where the same association text associated with the same object is displayed on any device that a user uses regardless of the attribute of the device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a controller including a processor configured to receive an attribute of a device that a user uses, and control, in accordance with the attribute of the device, a representation of association text such that, by selecting a representation of association text out of a plurality of representations of association text and displaying the selected representation of association text, motivation of the user of a behavior performed for an object displayed in a display region of the device is increased, the association text being associated with the object displayed in the display region of the device.

### BRIEF DESCRIPTION OF THE DRAWINGS

Exemplary embodiments of the present disclosure will be described in detail based on the following figures, wherein:

FIG. 1 is a diagram illustrating an example of the functional configuration of a controller;

FIG. 2 is a diagram illustrating an example of user information;

FIG. 3 is a diagram illustrating an example of device information;

FIG. 4 is a diagram illustrating an example of item information;

FIG. 5 is a diagram illustrating an example of behavior histories;

FIG. 6 is a diagram illustrating an example of the configuration of a principal part of an electrical system in the controller;

FIG. 7 is a flowchart illustrating an example of the flow of a control process;

FIG. 8 is a diagram illustrating the flow of the control process in Case 1;

FIG. 9 is a diagram illustrating a display example of a catch phrase in Case 1;

FIG. 10 is a diagram illustrating the flow of the control process in Case 2;

FIG. 11 is a diagram illustrating a display example of a catch phrase in Case 2;

FIG. 12 is a diagram illustrating the flow of the control process in Case 3;

FIG. 13 is a diagram illustrating a display example of a catch phrase in Case 3;

FIG. 14 is a diagram illustrating the flow of the control process in Case 4;

FIG. 15 is a diagram illustrating a display example of a catch phrase in Case 4; and

FIG. 16 is a diagram illustrating a display example of another catch phrase in Case 4.

### DETAILED DESCRIPTION

Hereinafter, exemplary embodiments of the present disclosure will be described with reference to drawings. The same component elements and the same processes will be referred to with the same reference signs throughout the drawings, and redundant explanation will not be provided.

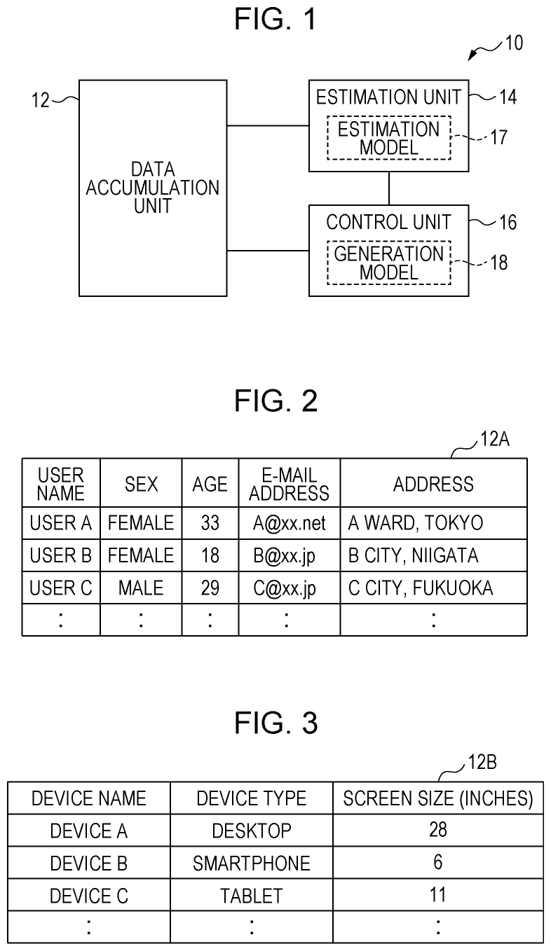

FIG. 1 is a diagram illustrating an example of the functional configuration of a controller 10 according to an exemplary embodiment. The controller 10 includes functional units, that is, a data accumulation unit 12, an estimation unit 14, a control unit 16. The estimation unit 14 includes an estimation model 17 for estimating a representation of association text. The control unit 16 includes a generation model 18 for, for example, generating a representation of association text that is associated with an object on the basis of various types of information including description text describing the object.

Description text represents a sentence describing at least one of the state and characteristics of an object. For example, in the case where an object is a product introduction for cheese rolls, text such as “Tuna cheese rolls made by rolling up a filling of tuna and cream cheese in a pancake dough. Pile bite-size cheese rolls up, and create a pretty roll tower of tuna and cheese flavor. Recommended for a party, and girls would love this product.” is used as description text for the product.

Association text represents a sentence or words that are associated with description text. Association text is an impressive sentence or impressive words that attract much interest of users and draw much attention of users compared to a case where details of an object are described using description text. There is no restriction on the number of characters of association text as long as it is associated with related description text. The number of characters of association text may be larger or smaller than the number of characters of related description text. Regarding the description text for cheese rolls mentioned above, for example, text concisely representing characteristics of a product, such as “Grab and bite” is used as association text.

Hereinafter, unless otherwise stated, the controller 10 will be described based on a case where, for example, content of a webpage of an electronic commerce (EC) website for introducing a product in a webpage and selling the product online to users is controlled. In this case, a product to be sold is an example of an object, and a catch phrase for a product described in description text is an example of association text. Products may be denoted by “items” from the point of view that the products are items to be sold.

Information regarding running of an EC website is accumulated in the data accumulation unit 12. Specifically, the data accumulation unit 12 includes user information 12A, device information 12B, item information 12C, and behavior histories 12D.

FIG. 2 is a diagram illustrating an example of the user information 12A. The user information 12A includes various types of information of users who have accessed an EC website through devices. In the example illustrated in FIG. 2, the user information 12A includes user name, sex, age, e-mail address, and address.

The user name represents an identifier of a user who has been registered to an EC website. The user name may not be a real name. The user name may be, for example, a nickname or a user identification (ID) represented by a collection of alphanumeric characters or symbols.

The sex represents the sex of a user represented by the user name. The age represents the age of a user represented by the user name. The e-mail address represents an e-mail address of a user represented by the user name. The address represents the address of a user represented by the user name.

The user information 12A may include at least a user name. Other types of information such as an e-mail address is not necessarily included in the user information 12A. Furthermore, an entry (for example, hobbies of a user) that is different from the entries of the user information 12A illustrated in FIG. 2 may be included in the user information 12A.

FIG. 3 is a diagram illustrating an example of the device information 12B. The device information 12B includes an attribute of a device used by a user who has accessed an EC website. In the example illustrated in FIG. 3, the device information 12B includes device name, device type, and screen size.

The device name represents an identifier for identifying a device that a user has used. For example, the model number, serial number, or a media access control (MAC) address of a device is set as the device name.

The device type represents the type of a device that a user has used. Types of devices include, for example, “desktop” representing a desktop-type computer, “smartphone” representing a palm-sized portable computer that may be operated by a user with a single hand while clutching the device, and a “tablet” representing a tablet-type computer that is portable but may not be clutched in one hand of a user. The device type is not limited to “desktop”, “smartphone”, or “tablet” and may include “wearable” representing a wearable computer such as a wrist-watch type computer.

The screen size represents the size of a display provided on a corresponding device, that is, the size of a display region in which a webpage is displayed. As the screen size, for example, a value representing the length of a diagonal line of a display in inches is used. Instead of the size of a display, the size of a window in which a webpage in which a product is posted is displayed may be associated with the size of a screen.

The device information 12B only needs to include information that is able to identify an attribute of a device used by a user when accessing an EC website. The device information 12B does not necessarily include all the device name, the device type, and the screen size. An attribute of a device represents information indicating identification of a device that a user uses. Thus, each of the device name, the device type, and the screen size is an example of an attribute of a device. Furthermore, an entry (for example, operating means of a device, such as a mouse and a touch panel) that is different from the entries of the device information 12B illustrated in FIG. 3 may be included in the device information 12B.

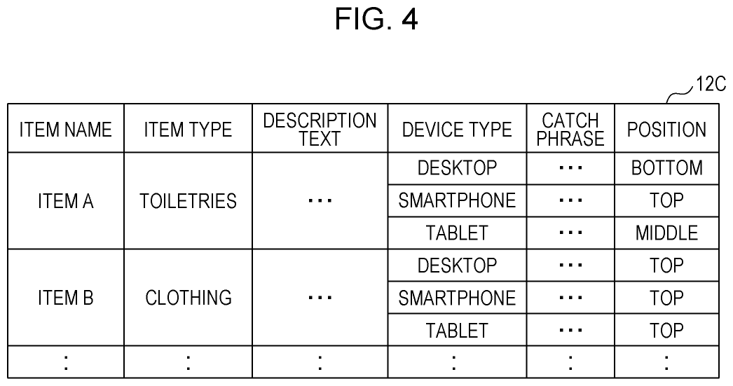

FIG. 4 is a diagram illustrating an example of the item information 12C. The item information 12C includes various types of information of a product, which is an example of an object. In the example illustrated in FIG. 4, the item information 12C includes item name, item type, description text, device type, catch phrase, and position.

The item name represents an identifier for identifying a product. For example, a product name or the model number of a product is set as the item name.

As the item type, the type of a product such as toiletries or clothing is set.

As the description text, a description sentence describing a product, for example, a sentence including details of characteristics of a product, a release date, and usage instructions is set.

The device type represents the type of a device that may be connected to an EC website. The device type is set for each item. In the example illustrated in FIG. 4, “desktop”, “smartphone”, and “tablet” are set for each item. That is, as is clear from FIG. 4, for example, a webpage in which items are posted is viewed using a device such as “desktop”, “smartphone”, or “tablet”.

As the catch phrase, for example, an impressive sentence or impressive words that are posted in a webpage along with a picture of a product and draw attention of a user who views the webpage are set.

The position is an example of positional information indicating the position in a webpage at which a catch phrase is posted. There is no restriction on a method for specifying a position. However, in the example illustrated in FIG. 4, the position of a catch phrase is specified from among top, middle, and bottom. For example, “top” represents the upper one-third of a webpage in which a corresponding item is posted, “bottom” represents the lower one-third of the webpage, and “middle” represents the middle one-third of the webpage, which does not belong to “top” or “bottom”. That is, “top” corresponds to a position at which a catch phrase is displayed in a display region of a device without scrolling of the webpage by a user. In contrast, “middle” and “bottom” correspond to positions at which a catch phrase is not displayed in the display region of a device unless a user scrolls the webpage, depending on the attribute of the device. Obviously, the amount of scroll on a webpage required to display a catch phrase in “bottom” is larger than a catch phrase in “middle”. The position of a catch phrase may be represented by a coordinate value set for a webpage.

A catch phrase and the position of the catch phrase are set for each device type for each item. That is, an EC website is able to change at least one of a catch phrase for a product posted in a webpage and the position of the catch phrase in accordance with the device type of a device that a user uses to view the webpage in which the product is posted.

In the example of the item information 12C illustrated in FIG. 4, “device type” is used as an entry representing identification of a device that a user uses to view a webpage. However, for example, an entry representing an attribute of a device, such as device name or screen size in the device information 12B, may be used in place of device type.

The item information 12C does not necessarily include the entries of the item information 12C illustrated in FIG. 4. The item information 12C may include an entry (for example, price of a product) that is different from the entries of the item information 12C illustrated in FIG. 4.

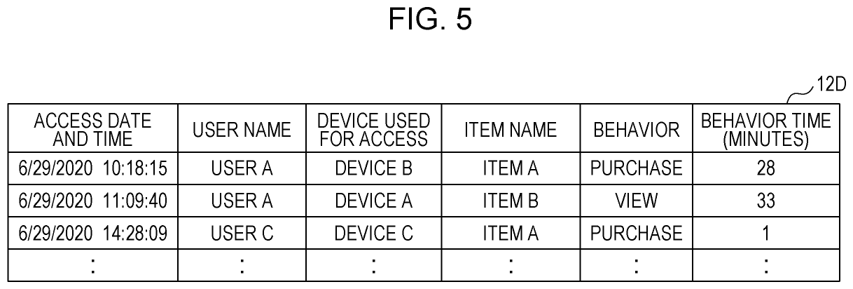

FIG. 5 is a diagram illustrating an example of the behavior histories 12D. The behavior histories 12D include records of behaviors performed by users for a product displayed in a display region of devices used for viewing of a webpage. In the example illustrated in FIG. 5, the behavior histories 12D include access date and time, user name, device used for access, item name, behavior, and behavior time.

The access date and time represents the date and time at which a user accessed an EC website using a device. The user name represents an identifier of a user who has accessed the EC website using a device. The device used for access represents an attribute (for example, a device name) of a device that a user has used to access the EC website. The item name represents an identifier (for example, a product name) of a product displayed in a display region of a device used by a user.

The behavior represents a behavior performed by a user for a product displayed in a display region of a device. “Purchase” as a behavior represents a user's behavior of purchasing a product represented by an item name. “View” as a behavior represents a user's behavior of only causing a webpage in which a product represented by an item name is posted to be displayed in a display region of a device but not purchasing the product. There is no restriction on the behavior of a user set as a behavior in the behavior histories 12D. For example, “search” may be set for a user's behavior of searching for a product, and “purchase cancel” may be set for a user's behavior of canceling purchase in the middle of process of purchasing a product.

The behavior time represents a time regarding a behavior of a user that has passed since display of a catch phrase for a product in a display region of a device. For example, in the case where “purchase” is set as a behavior, the time from display of a catch phrase for a product in a display region of a device to purchase of the product by a user is set as a behavior time. Furthermore, in the case where “view” is set as a behavior, the time from display of a catch phrase for a product in a display region of a device to transition to a webpage in which a different product is posited is set as a behavior time.

The behavior histories 12D may include, in addition to the entries of the behavior histories 12D illustrated in FIG. 5, for example, an entry such as the number of times that a user has scrolled on a webpage in which a product is posted until the product is displayed in a display region of a device.

The user information 12A, the device information 12B, the item information 12C, and the behavior histories 12D accumulated in the data accumulation unit 12 will be referred to as “accumulated data”.

For example, when a user accesses an EC website and performs an operation for transitioning to a webpage in which a product is posted, the estimation unit 14 receives an attribute of a device used by the user to view the webpage. The estimation unit 14 estimates, for each attribute of a device that a user uses, a target representation of a catch phrase that increases the motivation of the user of a behavior performed for a product displayed in a display region of the device that the user uses, compared to a case where the same product is displayed on a device different from the device that the user uses, on the basis of accumulated data accumulated in the data accumulation unit 12 and the attribute of the device used by the user to view a webpage.

For an EC website that sells a product, behaviors that a user may perform for the product include purchase of the product. That is, the estimation unit 14 estimates, for each attribute of a device that a user uses, a target representation of a catch phrase for a product that is likely to make the user buy the product, compared to a case where the same product is displayed on a device different from the device that the user uses.

A target representation of a catch phrase represents a target regarding at least one of wording of a catch phrase and presentation of a catch phrase.

The control unit 16 controls a representation of a catch phrase such that, for example, a representation of a catch phrase for a product generated using the generation model 18, which receives entries of the user information 12A, the device information 12B, and the item information 12C as inputs, gets close to a target representation estimated by the estimation unit 14. Furthermore, the control unit 16 controls content of a webpage such that a catch phrase that has been controlled to get close to the target representation estimated by the estimation unit 14 is posted in a webpage of an EC website.

Accordingly, the controller 10 performs control for changing, for each attribute of a device that a user uses and for each user, representation of a catch phrase for a product posted in a webpage such that the user becomes interested in the product.

Next, an example of the configuration of a principal part of an electrical system in the controller 10 will be described.

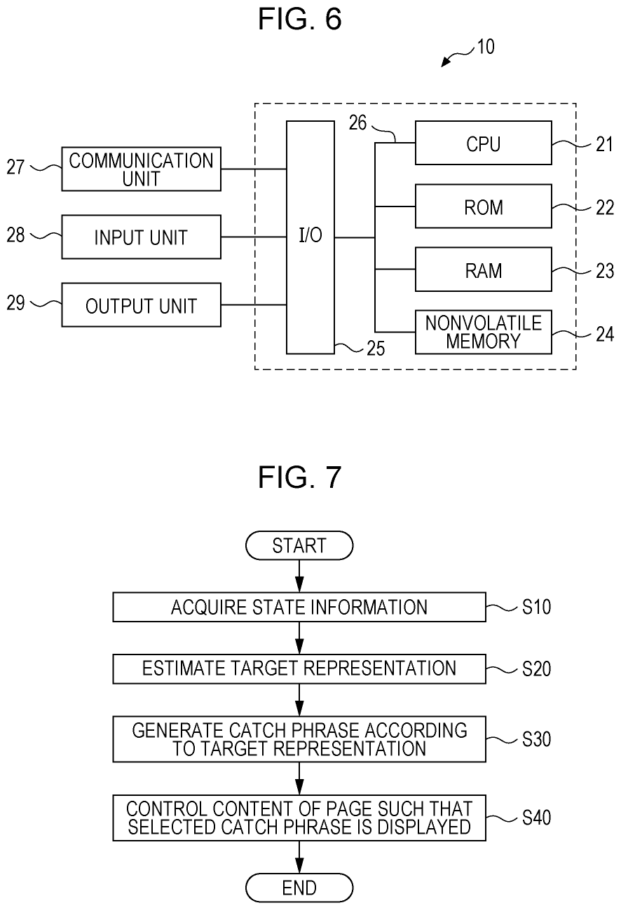

FIG. 6 is a diagram illustrating an example of the configuration of a principal part of an electrical system in the controller 10. The controller 10 includes, for example, a computer 20.

The computer 20 includes a central processing unit (CPU) 21 that manages processing of the functional units of the controller 10 illustrated in FIG. 1, a read only memory (ROM) 22 that stores a control program, a random access memory (RAM) 23 that is used as a temporary operation region for the CPU 21, a nonvolatile memory 24, and an input/output interface (I/O) 25. The CPU 21, the ROM 22, the RAM 23, the nonvolatile memory 24, and the I/O 25 are connected to one another via a bus 26.

The nonvolatile memory 24 is an example of a memory device in which stored information is maintained even when electric power supplied to the nonvolatile memory 24 is interrupted. For example, a semiconductor memory is used as the nonvolatile memory 24. However, the nonvolatile memory 24 may be a hard disk. The nonvolatile memory 24 is not necessarily built in the computer 20. The nonvolatile memory 24 may be, for example, a memory device that is detachable from the computer 20, such as a memory card. For example, accumulated data are stored in the nonvolatile memory 24.

For example, a communication unit 27, an input unit 28, and an output unit 29 are connected to the I/O 25.

The communication unit 27 is connected to a communication line, which is not illustrated in FIG. 6, and includes a communication protocol for communicating with an external device connected to a connection line, which is not illustrated in FIG. 6. The communication line may be a known communication line such as the Internet and a local area network (LAN). The communication line may be wired or wireless.

The input unit 28 is a device that receives an instruction from an operator of the controller 10 and notifies the CPU 21 of the instruction. The input unit 28 may include, for example, a button, a touch panel, a keyboard, a pointing device, and a mouse. The controller 10 may receive an instruction from a user as sound. In this case, a microphone is used as the input unit 28.

The output unit 29 is a device that outputs information processed by the CPU 21. The output unit 29 includes, for example, a display device such as a liquid crystal display or an organic electroluminescence (EL) display.

The controller 10 does not necessarily include the units connected to the I/O 25 illustrated in FIG. 6 and may include a unit necessary according to the situation. For example, in the case where the controller 10 is installed at an unmanned data center and an operator of the controller 10 operates the controller 10 by using a terminal installed at a location different from the data center, the input unit 28 and the output unit 29 may not need to be provided in the controller 10.

Next, an operation of the controller 10 will be described.

FIG. 7 is a flowchart illustrating an example of the flow of a control process performed by the CPU 21 of the controller 10. A control program defining the control process is stored in advance, for example, in the ROM 22 of the controller 10. The CPU 21 of the controller 10 reads the control program stored in the ROM 22 and performs the control process.

In step S10, the CPU 21 acquires from an EC website the user name of a user who has accessed the EC website, a device name, which is an example of an attribute of a device used by the user to access the EC website, and the item name of a product posted in a webpage that the user is going to display. Hereinafter, information including an identifier for identifying a user, such as the user name, an attribute of a device that indicates identification of a device, such as the device name, and an identifier for identifying a product, such as the item name, will be referred to as “state information”. The operator of the controller 10 may cause the input unit 28 to notify the CPU 21 of the state information or the CPU 21 may acquire the state information from a device that has accessed the EC website.

In step S20, the CPU 21 estimates, using the estimation model 17 that has performed machine learning of a representation tendency of a catch phrase provided to a product that has been purchased with the device represented by the device name and by the user represented by the user name, a target representation for the product that the user is going to view on the device specified by the state information. To distinguish between a product that the user is going to view and products that the user previously viewed or purchased on the EC website, the product that the user is going to view will be referred to as a “presented product”.

The CPU 21 acquires, out of the behavior histories 12D, a behavior history 12D in which “purchase” is set as a behavior. Hereinafter, out of the behavior histories 12D, a behavior history 12D for a case where a behavior that is desired to be performed by a user (in this case, purchase of a product) has been performed will be referred to as a “behavior history 12D of a positive example”.

The CPU 21 repeatedly performs machine learning using estimation learning data in which entries obtained from the user information 12A of the user represented by the user name included in the behavior history 12D of the positive example, the device information 12B of the device represented by the device name included in the behavior history 12D of the positive example, and the item information 12C of the product represented by the item name included in the behavior history 12D of the positive example serve as inputs and a specific representation of interest as the target representation, out of representations regarding the catch phrase for the product represented by the item name included in the behavior history 12D of the positive example, is regarded as a correct answer.

Specifically, the CPU 21 performs machine learning using estimation learning data in which the user name, the device type corresponding to the device name set as the device used for access, and the item type corresponding to the item name in the behavior history 12D of the positive example serve as inputs and a specific representation regarding the catch phrase for the product of interest as the target representation is regarded as a correct answer. Entries configuring the estimation learning data are represented by, for example, vectors of predetermined dimensions.

Representation regarding a catch phrase for a product of interest as a target representation may be any representation regarding the product, such as a catch phrase for the product, the number of characters of the catch phrase, the size of the catch phrase, the color of the catch phrase, and the position of the catch phrase in a webpage in which the product is posted.

For example, in the case where a specific representation of interest as a target representation is a catch phrase for a product, the CPU 21 repeatedly performs machine learning using estimation learning data in which entries obtained from the user information 12A of a user represented by a user name included in the behavior history 12D of the positive example, the device information 12B of a device represented by a device name included in the behavior history 12D of the positive example, and the item information 12C of a product represented by an item name included in the behavior history 12D of the positive example serve as inputs and a catch phrase for the product represented by the item name included in the behavior history 12D of the positive example is regarded as a correct answer.

A catch phrase posted along with a product has a role to draw attention of a user to the product. Thus, the fact that the user has purchased the product means that the user has paid attention to the product. That is, the representation regarding the catch phrase for the product represented by the item name included in the behavior history 12D of the positive example is a representation of a catch phrase that more suits preferences of the user and draws more attention of the user than other representations of the catch phrase on the device type of the device that the user uses.

Thus, in the case where a user name, a device type corresponding to a device name, and an item type of a presented product that have been notified through the state information are input to the estimation model 17 obtained from machine learning using estimation learning data, the estimation model 17 outputs a target representation of a catch phrase that draws more attention of a user, such as a representation of a catch phrase that makes the user more interested in the presented product than other representations of the catch phrase, in the case where the user represented by the user name views the presented product with the device represented by the device name. For example, an encoder/decoder model or a multilayer perceptron model may be used as the estimation model 17.

As described above, the CPU 21 estimates, using the estimation model 17 built in advance, a target representation of a catch phrase for the presented product. Entries input to the estimation model 17 are also represented by vectors.

Obviously, the CPU 21 may perform machine learning of the estimation model 17 using estimation learning data including not only the behavior history 12D of the positive example but also a behavior history 12D for the case where a product has not been purchased, that is, a behavior history 12D of a negative example. In the case where estimation learning data including the behavior histories 12D of the positive example and the negative example is used for machine learning of the estimation model 17, values of behaviors indicating whether or not a product represented by an item name has been purchased may additionally serve as inputs in the estimation learning data, and machine learning of the estimation model 17 is performed using the estimation learning data. Hereinafter, an example in which estimation learning data generated from the behavior history 12D of the positive example will be described.

The estimation model 17 for estimating a target representation of a catch phrase is not necessarily obtained by machine learning. For example, a statistical estimation such as Bayes estimation or an operation method using a function representing the relationship between an input and a correct answer, such as Fermi estimate, may be used.

Furthermore, the estimation model 17 may be built by the CPU 21. However, a target representation of a catch phrase for a presented product may be estimated using the estimation model 17 built by an external device instead of by the CPU 21.

In step S30, the CPU 21 generates a representation of a catch phrase to be provided to the presented product such that the representation of the catch phrase to be provided to the presented product gets close to the target representation estimated in step S20 in the case where the user corresponding to the user name specified by the state information views the webpage in which the presented product is posted, using the device corresponding to the device name specified by the state information.

The representation of the catch phrase to be provided to the presented product is generated using the generation model 18. For example, the generation model 18 is obtained by repeatedly performing machine learning using generation learning data in which entries obtained from the user information 12A of a user represented by a user name included in the behavior history 12D of the positive example, the device information 12B of a device represented by a device used for access included in the behavior history 12D of the positive example, and the item information 12C of a product represented by an item name included in the behavior history 12D of the positive example serve as inputs and a catch phrase for the product represented by the item name for the device type of the device represented by the device used for access is regarded as a correct answer.

Specifically, generation learning data in which the user name, the device type corresponding to the device name set as the device used for access, and the item type corresponding to the item name in the behavior history 12D of the positive example, description text corresponding to the item name, and a representation to be estimated for a catch phrase corresponding to a combination of the device type corresponding to the device name and the item name serve as inputs and the catch phrase is regarded as a correct answer is used. The entries configuring the generation learning data are represented by, for example, vectors of predetermined dimensions. For example, an encoder/decoder model may be used as the generation model 18.

The CPU 21 inputs the user name, the device type corresponding to the device name, and the item type corresponding to the item name of the presented product that have been notified through the state information and the target representation estimated in step S20 to the generation model 18, and thus generates a catch phrase for the presented product according to the target representation. The entries to be input to the generation model 18 are also represented by vectors.

The generation model 18 may be built by the CPU 21. However, a catch phrase for a presented product according to the target representation may be estimated using the generation model 18 built by an external device instead of by the CPU 21.

The generation model 18 for generating a catch phrase is not necessarily obtained by machine learning. For example, the generation model 18 for generating a catch phrase using Markov chain or the generation model 18 for generating a catch phrase using a sentence compression technique may be used.

In step S40, the CPU 21 controls the layout of a webpage such that the catch phrase for the presented product generated in step S30 is displayed in the webpage in which the presented product is posted, and ends the control process illustrated in FIG. 7.

Accordingly, for each device type that a user uses to display a presented product, a representation of a catch phrase that more suits preferences of the user and draws more attention of the user than other representations of the catch phrase is displayed. Thus, compared to a case where the same representation of a catch phrase for the same presented product is used for all devices regardless of the attributes of the devices, a tendency of increasing the probability of purchase of the presented product by a user is achieved.

The state information may not include a user name. In the case where the state information does not include a user name, machine learning of the estimation model 17 and the generation model 18 is performed using estimation learning data and generation learning data not including a user name. In such situations, in the case where a target representation of a catch phrase for a presented product is estimated using the estimation model 17, a user name that has been notified through the state information does not need to be input to the estimation model 17. Furthermore, in the case where a catch phrase for a presented product is generated using the generation model 18, a user name that has been notified through the state information does not need to be input to the generation model 18.

In the case where the CPU 21 performs machine learning of the estimation model 17 and the generation model 18, machine learning of the models may be performed individually or concurrently. Furthermore, obtained loss may be back-propagated to the estimation model 17 from the generation model 18 so that loss representing a difference between the representation of a catch phrase generated using the generation model 18 and a target representation, and learning of the estimation model 17 and the generation model 18 may then be performed again.

The CPU 21 may perform machine learning of the generation model 18 such that the degree of influence of a specific part of a character string representing content of a specific entry used as an input on generation of a catch phrase using the generation model 18 is higher than the degree of influence of a part different from the specific part on generation of the catch phrase using the generation model 18.

For example, there may be a case where description text is updated and both description text of an old version and description text of a new version exist. An updated part includes content that is desired to appeal more to a user and desired to be described more in detail than a non-updated part. Thus, the CPU 21 extracts a difference between the description text of the old version and the description text of the new version.

Then, for input of description text of the new version for the item information 12C to machine learning of the generation model 18, the CPU 21 applies more weighting to a character string of the description text of the new version that corresponds to the difference than a character string that does not correspond to the difference and then inputs the description text processed as described above to the machine learning of the generation model 18. Specifically, for example, the CPU 21 applies more weighting to a vector representing the character string corresponding to the difference, out of vectors representing character strings of words in the description text that have been obtained by division into morphemes by morphological analysis, than a vector representing a character string not corresponding to the difference. Accordingly, the generation model 18 for generating a catch phrase that is more affected by the character string corresponding to the difference than the character string not corresponding to the difference is obtained.

The difference extracted by the CPU 21 may be a difference between description text for a product and description text for another product to be compared with the product.

Next, an example of representation of a catch phrase to be controlled will be described.

### <Case 1: Number of Characters of Catch Phrase>

An example in which the number of characters of a catch phrase for a presented product is controlled will be described.

The number of characters of a catch phrase that draws attention of a user may differ according to the type of device that the user uses. The screen of a smartphone is narrower than the screen of a desktop computer. Thus, in the case where a catch phrase with the same number of characters as the number of characters of a catch phrase displayed on the screen of the desktop computer is displayed on the screen of the smartphone, a phrase may be split across two lines, and this may cause a difficulty in reading the catch phrase. Some users may not like a catch phrase split across two lines. Thus, a short catch phrase with no line break draws attention of such users.

Thus, by estimating, for a device type of a device that a user uses, how many number of characters a catch phrase has so that the catch phrase is able to attract attention of the user and controlling the number of characters of the catch phrase such that the number of characters of the catch phrase for a presented product gets close to the estimated number of characters, the catch phrase is able to draw attention of the user.

The determination as to whether or not a catch phrase draws attention of a user is based on whether or not the user has purchased a product. The fact that a user has purchased a product represents that the user has paid attention to a catch phrase for the product. That is, the number of characters of a catch phrase that is able to draw attention of a user is an example of a target representation of a catch phrase.

The estimation model 17 is generated by machine learning using estimation learning data in which the user name, a device type corresponding to a device name set as the device used for access, and an item type corresponding to the item name in the behavior history 12D of the positive example serve as inputs and the number of characters of a catch phrase associated with the input device type, out of catch phrases corresponding to the input item name, is regarded as a correct answer.

Thus, in step S20 of FIG. 7, the CPU 21 inputs the user name, the device type corresponding to the device name, and the item type of the presented product that have been notified through the state information to the estimation model 17, and thus estimates the number of characters of a catch phrase for the presented product that is able to draw attention of the user (referred to as the “target number of characters”) for the device type of the device that the user uses.

Furthermore, the generation model 18 is generated by machine learning using generation learning data in which the user name, the device type corresponding to the device name set as the device used for access, the item type corresponding to the item name, and the description text corresponding to the item name in the behavior history 12D of the positive example, and the number of characters of the catch phrase associated with the device type corresponding to the device name set as the device used for access, out of the catch phrases corresponding to the item name, serve as inputs and the corresponding catch phrase is regarded as a correct answer.

The example in which the generation model 18 is generated by machine learning of generation learning data generated from the behavior history 12D of the positive example has been described above. However, machine learning of the generation model 18 may be performed also using generation learning data generated from the behavior history 12D of the negative example. By also using generation learning data generated from the behavior history 12D of the negative example, elements common to the behavior history 12D of the positive example and the behavior history 12D of the negative example are able to be obtained.

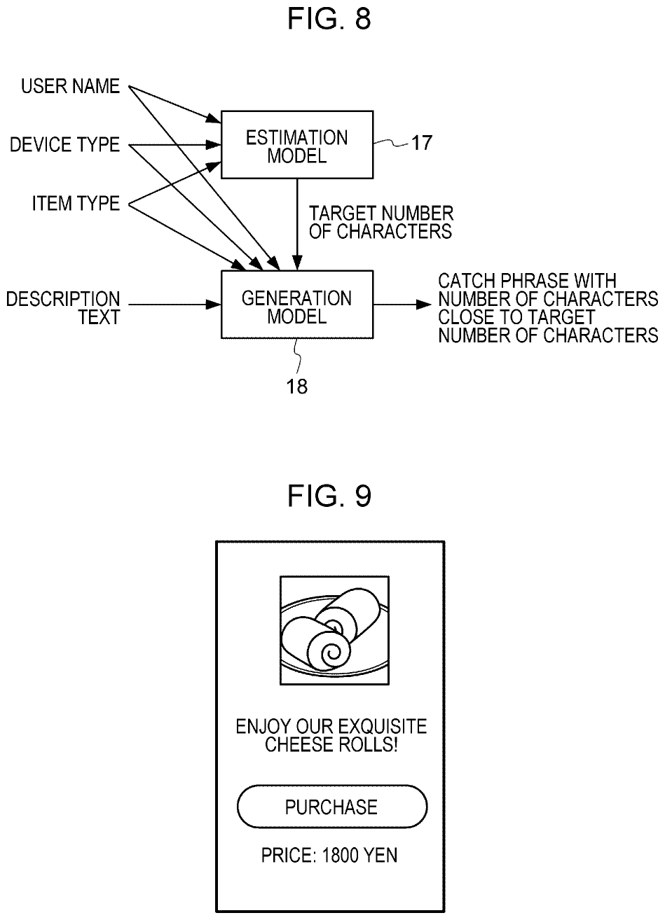

Thus, in step S30 of FIG. 7, the CPU 21 inputs the user name, the device type corresponding to the device name, the item type corresponding to the item name of the presented product, and the description text for the presented product that have been notified through the state information to the generation model 18, and the target number of characters estimated using the estimation model 17 to the generation model 18, and thus generates a catch phrase for the presented product with the number of characters close to the target number of characters. FIG. 8 is a diagram illustrating the flow of a part of the control process corresponding to steps S20 and S30 in Case 1.

Then, in step S40 of FIG. 7, the CPU 21 controls the layout of a webpage such that the catch phrase for the presented product with the number of characters that has been adjusted to get close to the target number of characters is displayed in the webpage in which the presented product is posted.

FIG. 9 is a diagram illustrating a display example of a catch phrase for a case where a presented product is cheese rolls. In the case where the target number of characters is thirty-three (including spaces), for example, a catch phrase “Enjoy our exquisite cheese rolls!” is displayed on a device that a user uses.

The CPU 21 may generate a plurality of catch phrases in accordance with the target number of characters, using, in addition to the generation model 18 obtained by performing machine learning of generation learning data, other generation models 18 prepared in advance. In this case, the CPU 21 may select a catch phrase whose number of characters is close to the target number of characters from among the plurality of catch phrases. Furthermore, the CPU 21 may set the upper limit of the number of characters with reference to the target number of characters and select a catch phrase from among catch phrases not including catch phrases whose number of characters exceeds the upper limit. Furthermore, the CPU 21 may set the upper limit and lower limit of the number of characters with reference to the target number of characters and select a catch phrase from among catch phrases whose number of characters is equal to or more than the lower limit and less than or equal to the upper limit.

As another generation model 18, for example, an encoder/decoder model in which entries of the item information 12C for a presented product are input to the encoder and the decoder predicts a catch phrase on the basis of outputs from the encoder is used. With the use of such encoder/decoder model, even in the case where no description text is set for the presented product, a catch phrase for the presented product is generated based on other entries for the presented product (for example, price and dimensions of the presented product).

Furthermore, the generation model 18 that analyzes context of the description text for the presented product and outputs a summary of the description text as a catch phrase for the presented product in accordance with the target number of characters generated from the result of analysis of the context may be used.

### <Case 2: Position of Catch Phrase>

An example in which the position of a catch phrase for a presented product in a webpage is controlled will be described. The screen of a smartphone is narrower than the screen of a desktop computer. Thus, in the case where a catch phrase for a product is posted in a bottom part of a webpage, a situation in which the catch phrase is displayed on the screen of the desktop computer but not displayed on the screen of the smartphone may occur. Therefore, some users may pay more attention to the catch phrase if the catch phrase is placed in a top part of the webpage because the catch phrase in the top part of the webpage is able to be displayed without requiring scrolling the webpage.

In contrast, some users may pay more attention to a catch phrase posted in the bottom part of the webpage than a catch phrase posted in the top part of the webpage because the catch phrase in the bottom part of the webpage suddenly appears when the webpage is scrolled.

As described above, depending on the device type or depending on the user even in the case where the same device is used, the position of a catch phrase that draws attention of the user may vary. Thus, for a device type of a device that a user uses, the position in a webpage at which a catch phrase is to be posted so that the catch phrase is able to attract attention of the user may be estimated, and the position of the catch phrase may be controlled such that the catch phrase for the presented product in the webpage is arranged at the estimated position. The position of a catch phrase that is able to draw attention of a user is an example of a target representation of a catch phrase.

The estimation model 17 is generated by machine learning using estimation learning data in which the user name, a device type corresponding to a device name set as the device used for access, and an item type corresponding to the item name in the behavior history 12D of the positive example serve as inputs and a position corresponding to the input item name is regarded as a correct answer.

Thus, in step S20 of FIG. 7, the CPU 21 inputs the user name, the device type corresponding to the device name, and the item type of the presented product that have been notified through the state information to the estimation model 17, and thus estimates the position of a catch phrase for the presented product in the web page that is able to draw attention of the user (referred to as a “target position”) for the device type of the device that the user uses.

Furthermore, the generation model 18 is generated by machine learning using generation learning data in which the user name, the device type corresponding to the device name set as the device used for access, the item type corresponding to the item name, and the description text corresponding to the item name in the behavior history 12D of the positive example serve as inputs and a catch phrase associated with the device type corresponding to the device name set as the device used for access, out of catch phrases corresponding to the item name, and the position of the catch phrase corresponding to the item name are regarded as a correct answer.

The example in which the generation model 18 is generated by machine learning of generation learning data generated from the behavior history 12D of the positive example has been described above. However, machine learning of the generation model 18 may be performed also using generation learning data generated from the behavior history 12D of the negative example.

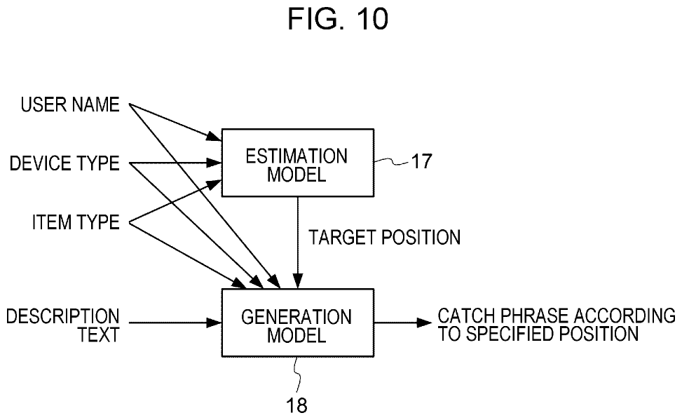

Thus, in step S30 of FIG. 7, the CPU 21 inputs to the generation model 18 the user name, the device type corresponding to the device name, the item type corresponding to the item name of the presented product, and the description text for the presented product that have been notified through the state information to the generation model 18, and thus generates a catch phrase for the presented product and the position of the catch phrase (referred to as a “specified position”). FIG. 10 is a diagram illustrating the flow of a part of the control process corresponding to steps S20 and S30 in Case 2.

Then, in step S40 of FIG. 7, the CPU 21 controls the layout of a webpage such that the catch phrase for the presented product is displayed at the specified position in the webpage in which the presented product is posted.

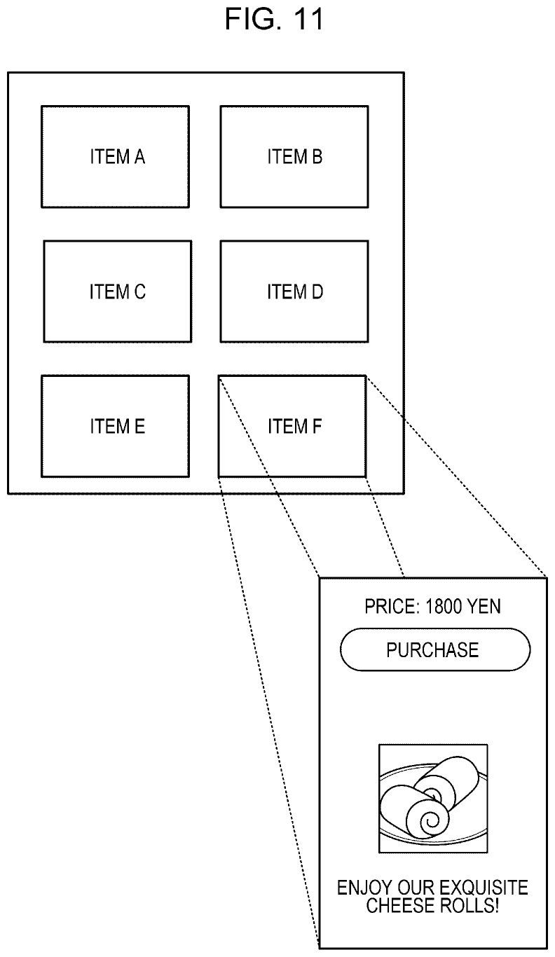

FIG. 11 is a diagram illustrating a display example of a catch phrase for a case where a presented product is cheese rolls. In the case where a specified position is “bottom”, for example, a catch phrase for cheese rolls, such as “Enjoy our exquisite cheese rolls!” is posted in a bottom part of a webpage. Thus, as illustrated FIG. 11, for example, in a webpage in which six products are posted per page, a catch phrase for cheese rolls is posted in a posting range corresponding to product F or product E (FIG. 11 illustrates an example in which the catch phrase for cheese rolls is posted in a posting range for product F). Furthermore, as illustrated in FIG. 11, the catch phrase may also be displayed in a bottom part of the posting range for the product.

The CPU 21 may control the layout of a webpage such that a catch phrase whose number of character has been adjusted based on the target number of characters generated in Case 1 is displayed at a specified position in a webpage in which a presented product is posted. Furthermore, the CPU 21 may control at least one of the size, color, and font of characters of a catch phrase, as well as the position of the catch phrase. In this case, information of the size, color, and font of a catch phrase for each catch phrase for a product represented by an item name for each device type is recorded in the item information 12C, and an estimation target for a target representation is changed from the position of a catch phrase to one of the size, color, and font of a catch phrase. Accordingly, the size, color, and font of a catch phrase that is able to draw attention of a user is able to be obtained by performing the same processing as the processing for generating the position of the catch phrase.

### <Case 3: Style of Catch Phrase>

An example in which the style of a catch phrase for a presented product is controlled will be described. The style of a catch phrase represents a representation format of a catch phrase.

As described above, for example, description text for cheese rolls is “Bite-size tuna cheese rolls made by rolling up a filling of tuna and cream cheese in a dough. Pile these cheese rolls up to look good in pictures.”. A catch phrase “Grab and bite” for the description text is a high-impact short expression representing the most appealing characteristics of the product. Thus, such a catch phrase may be regarded as an example of a catch phrase that belongs to a style that is able to catch the eyes of users. Furthermore, a catch phrase “Let's have a party with a tower of cream cheese tuna rolls” may be regarded as an example of a catch phrase that belongs to a style for describing the details of a product.

As described above, there are a variety of styles of catch phrases, and users likes different styles of catch phrases. Furthermore, a display region of a desktop computer is often larger than a display region of a smartphone, and a catch phrase and description text for a product are often posted together in a webpage for desktop computers. In such a case, details of the product may be obtained from the description text. Thus, a catch phrase with a style that is able to catch the eyes of a user may draw attention of the user compared to a catch phrase with a style for describing the details of a product. In contrast, description text for a product is often not displayed on a smartphone with a display region smaller than the display region of a desktop computer. Thus, a catch phrase for describing the details of a product may draw more attention of a user than a catch phrase with a style that is able to catch the eyes of the user.

Thus, for a device type of a device that a user uses, the style of a catch phrase that is able to attract attention of the user may be estimated, and the style of the catch phrase may be controlled such that the style of the catch phrase for the presented product gets close to the estimated style. The style of a catch phrase that is able to draw attention of a user is an example of a target representation of a catch phrase.

The estimation model 17 is generated by machine learning using estimation learning data in which the user name, a device type corresponding to a device name set as the device used for access, and an item type corresponding to the item name in the behavior history 12D of the positive example serve as inputs and the style of a catch phrase associated with the input device type is regarded as a correct answer. Specifying a style may be represented by, for example, “eye-catching” and “describing details”.

Thus, in step S20 of FIG. 7, the CPU 21 inputs the user name, the device type corresponding to the device name, and the item type of the presented product that have been notified through the state information to the estimation model 17, and thus estimates the style of a catch phrase for the presented product that is able to draw attention of the user (referred to as a “target style”) for the device type of the device that the user uses.

Furthermore, the generation model 18 is generated by machine learning using generation learning data in which the user name, the device type corresponding to the device name set as the device used for access, the item type corresponding to the item name, and the description text corresponding to the item name in the behavior history 12D of the positive example, and the style of the catch phrase associated with the device type, out of catch phrases corresponding to the item name, serve as inputs and a catch phrase associated with the device type corresponding to the device name set as the device used for access, out of the catch phrases corresponding to the input item name, is regarded as a correct answer.

The example in which the generation model 18 is generated by machine learning of generation learning data generated from the behavior history 12D of the positive example has been described above. However, machine learning of the generation model 18 may be performed also using generation learning data generated from the behavior history 12D of the negative example.

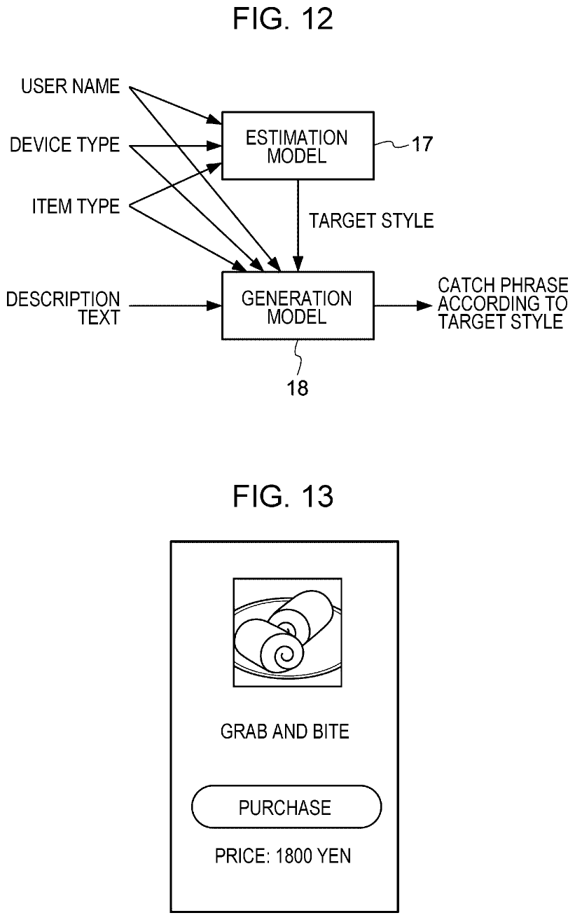

Thus, in step S30 of FIG. 7, the CPU 21 inputs the user name, the device type corresponding to the device name, the item type corresponding to the item name of the presented product, and the description text for the presented product that have been notified through the state information to the generation model 18, and the target style estimated using the estimation model 17 to the generation model 18, and thus generates a catch phrase for the presented product according to the target style. FIG. 12 is a diagram illustrating the flow of a part of the control process corresponding to steps S20 and S30 in Case 3.

Then, in step S40 of FIG. 7, the CPU 21 controls the layout of a webpage such that the catch phrase for the presented product that has been adjusted to get close to the target style is displayed in the webpage in which the presented product is posted.

FIG. 13 is a diagram illustrating a display example of a catch phrase for a case where a presented product is cheese rolls. In the case where a target style is a style that catches eyes, for example, a catch phrase “Grab and bite” is displayed on a device that a user uses.

For machine learning of the estimation model 17 and the generation model 18, a style of a catch phrase needs to be provided in advance to each catch phrase included in estimation learning data and generation learning data. Styles may be manually provided to catch phrases (referred to as “annotation”). However, the style of a catch phrase may be estimated on the basis of the similarity between description text for a product and the catch phrase.

Specifically, the CPU 21 calculates the similarity between description text corresponding to the item name in the behavior history 12D of the positive example and a catch phrase associated with the device type corresponding to the device name set as the device used for access in the behavior history 12D of the positive example, out of catch phrases corresponding to the item name.

Description text is a sentence describing at least one of the state and characteristics of a product. Thus, the tone of a catch phrase gets closer to a tone of describing something as the catch phrase becomes more similar to the description text. In contrast, a catch phrase becomes a high-impact sentence summarizing characteristics of a product as the catch phrase becomes less similar to the description text. Thus, the CPU 21 may provide “describing details” as the style of a catch phrase when the similarity between the catch phrase and the description text is high, and may provide “eye-catching” as the style of a catch phrase when the similarity between the catch phrase and the description text is low.

The similarity between a catch phrase and description text may be determined based on, for example, a known index value such as ROUGE score, edit distance, and term frequency-inverse document frequency (TF-IDF) representing the similarity between sentences.

For example, in the case where a catch phrase “Grab and bite” is associated with description text for a product, such as “A snack popular in Bangalore Region, India”, because the catch phrase does not include an expression used in the description text, the similarity between the catch phrase and the description text is relatively low. Thus, the style “eye-catching” may be provided to the catch phrase. In contrast, in the case where a catch phrase “Let's have a party with a tower of cream cheese tuna rolls” is associated with description text for a product, such as “A tower of cream cheese tuna rolls”, because the catch phrase includes an expression used in the description text, the similarity between the catch phrase and the description text is relatively high. Thus, the style “describing details” may be provided to the catch phrase.

Furthermore, a style may be provided to a catch phrase in accordance with clustering of catch phrases.

The CPU 21 classifies catch phrases into clusters by using a known cluster analysis method such as Ward's method, a group average method, and k-means method for catch phrases associated with a device type corresponding to a device name set as the device used for access in the behavior history 12D of the positive example.

Then, the CPU 21 provides cluster identifiers associated the clusters (for example, “cluster A”, “cluster B”, etc.) as styles of catch phrases included in the clusters.

A cluster is a collection of catch phrases having common meaning. Thus, unlike the case where the style of a catch phrase is provided in accordance with the similarity between the catch phrase and description text, there is no need to define a word representing a style, such as “eye-catching” or “describing details” in accordance with the similarity between the catch phrase and the description text.

A catch phrase for a presented product generated using the generation model 18 may include a plurality of sentences such as, “Each bite is irresistible! Gourmet cheese rolls made of fresh tuna.”. According to analysis of the styles of the sentences included in the catch phrase, for example, the sentence “Each bite is irresistible!” has an eye-catching style, and the sentence “Gourmet cheese rolls made of fresh tune.” has a style for describing details. As described above, in the case where a catch phrase for a presented product includes a plurality of sentences of different styles, the CPU 21 may control the order of sentences arranged.

For example, the sentences may be arranged sequentially, such as “Gourmet cheese rolls made of fresh tuna. Each bite is irresistible!”, or the sentences may be arranged separately, such as “Each bite is irresistible!” and “Gourmet cheese rolls made of fresh tuna.”

The styles of the sentences included in the catch phrase may be manually provided or provided by the CPU 21 in accordance with the similarity between the description text for the product and each of the sentences included in the catch phrase.

### <Case 4: Generation of Catch Phrase in View of Behavior Time>

An example in which a representation of a catch phrase for a presented product is controlled taking into consideration a behavior time of a user recorded in the behavior history 12D will be described.

As described above, the behavior time in the behavior history 12D represents a time regarding a behavior of a user that has passed since display of a catch phrase for a product in a display region of a device. In the example of the behavior history 12D illustrated in FIG. 5, the user A takes twenty-eight minutes to purchase the item A in the case where the user A uses the device B, and the user C takes one minute to purchase the item A in the case where the user C uses the device C.

As described above, even for the same product, the time required to purchase the product since display of a catch phrase for the product in a display region of a device may vary depending on the user. Variations in the time required to purchase a product relates to behavioral tendencies of users during a period up to the time when the product is purchased.

In the case where a user takes only a relatively short time, such as about one minute, to purchase a product, it is considered that the user has a high tendency to determine whether or not to purchase the product, only by viewing a catch phrase or description text for the product. In contrast, in the case where a user takes a relatively long time, such as about thirty minutes, to purchase a product, it is considered that the user has a high tendency to determine whether or not to purchase the product, after viewing information of another product (referred to as a “comparative product”) to be compared with the product posted in a webpage on a device and comparing the product with the comparative product. As described above, the behavioral tendency of a user regarding a behavior of purchasing a product may be estimated based on the behavior time of the user.

For a user who determines whether or not to purchase a product only by viewing a catch phrase or description text for the product, for example, it is desirable that a catch phrase that highlights the excellence of the product, such as improvement by upgrading of the product, is posted in a webpage so that the catch phrase is able to draw attention of the user. In contrast, for a user who determines whether or not purchase a product after comparing the product with a comparative product, it is desirable that a catch phrase that highlights the excellence of the product based on comparison with other products, such as differentiation from the comparative product, is posted in a webpage so that the catch phrase is able to draw attention of the user.

Regarding catch phrases for products purchased by users recorded in the behavior history 12D, the tendency of a catch phrase that suits the behavioral tendency of each user who purchases a product on a device is indicated for each device type. Thus, by using the generation model 18 that has estimated, using the behavior history 12D of the positive example, a behavior time required for each user to purchase a product for each device type and learned a catch phrase that suits the behavioral tendency of the user represented by the behavior time for the device type, a catch phrase for a presented product that suits the behavioral tendency of the user may be generated for the device type. Wording of a catch phrase for a presented product that suits the behavioral tendency of a user is an example of a target representation of a catch phrase.

The estimation model 17 is generated by machine learning using estimation learning data in which the user name, a device type corresponding to a device name set as the device used for access, and an item type corresponding to the item name in the behavior history 12D of the positive example serve as inputs and the behavior time is regarded as a correct answer.

Thus, in step S20 of FIG. 7, the CPU 21 inputs the user name, the device type corresponding to the device name, and the item type of the presented product that have been notified through the state information to the estimation model 17, and thus estimates a time required for the user to purchase the presented product since display of the presented product in the display region of the device that the user uses (referred to as a “device behavior time”) for the device type of the device that the user uses.

Furthermore, the generation model 18 is generated by machine learning using generation learning data in which the user name, the device type corresponding to the device name set as the device used for access, the item type corresponding to the item name, the description text corresponding to the item name, and the behavior time in the behavior history 12D of the positive example serve as inputs and a catch phrase associated with the device type corresponding to the device name set as the device used for access, out of catch phrases corresponding to the item name, is regarded as a correct answer.

The example in which the generation model 18 is generated by machine learning of generation learning data generated from the behavior history 12D of the positive example has been described above. However, machine learning of the generation model 18 may be performed also using generation learning data generated from the behavior history 12D of the negative example.

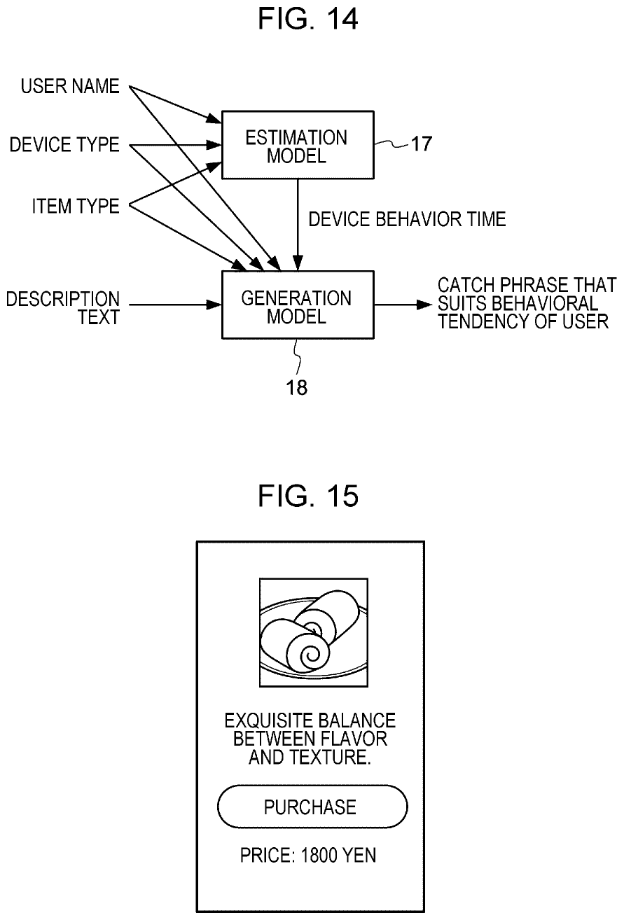

Thus, in step S30 of FIG. 7, the CPU 21 inputs the user name, the device type corresponding to the device name, the item type corresponding to the item name of the presented product, and the description text for the presented product that have been notified through the state information to the generation model 18, and the device behavior time estimated using the estimation model 17 to the generation model 18, and thus generates a catch phrase for the presented product that suits the behavioral tendency of the user represented by the device behavior time. FIG. 14 is a diagram illustrating the flow of a part of the control process corresponding to steps S20 and S30 in Case 4.

Then, in step S40 of FIG. 7, the CPU 21 controls the layout of a webpage such that the catch phrase for the presented product generated taking into consideration the behavioral tendency of the user is displayed in the webpage in which the presented product is posted.

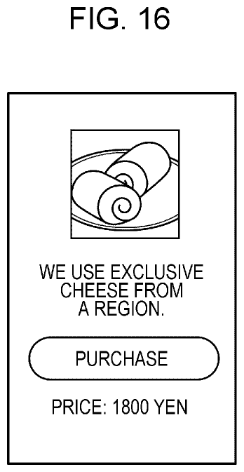

FIG. 15 is a diagram illustrating a display example of a catch phrase for a case where a presented product is cheese rolls. In the case where the device behavior time is relatively short, for example, a catch phrase that highlights the excellence of the product, such as “Exquisite balance between flavor and texture.”, is displayed on a device that a user uses. Furthermore, in the case where the device behavior time is relatively long, a catch phrase that highlights the excellence of the product based on comparison with other products, such as “We use exclusive cheese from A Region.”, is displayed on a device that a user uses, as illustrated in FIG. 16.

The CPU 21 may generate a plurality of catch phrases that suit the behavioral tendency of a user according to the device type, using other generation models 18 prepared in advance, in addition to the generation model 18 generated by machine learning of generation learning data. In this case, the CPU 21 may select, by taking into consideration a different target representation such as the target number of characters of a catch phrase that is able to draw attention of a user, which has been separately estimated in accordance with the device type of the device that the user uses, a catch phrase that is closest to the different target representation from among the plurality of catch phrases.

Control of the representation of association text by the controller 10 has been described by taking a catch phrase for a product on an EC website for the purpose of selling as an example. However, association text is not limited to a catch phrase for a product.

For example, an entry of an article is a sentence or word that is associated with the article and is thus an example of association text. The article corresponds to description text. By applying the controller 10 to control of a news website established on the Internet in which an article is displayed when a user selects an entry of news, an entry that draws attention of a user is generated for each article, and for example, the degree of viewing of the article may be improved compared to the case where an editor manually sets entries. The degree of viewing of an article is represented by the number of times an entry is selected and selection ratio.

In this case, an object is an entry of an article, and a behavior of a user performed for the object is selection of the entry.

In the example of selling of a product on an EC website, in the case where description text is an “article”, a catch phrase is an “entry”, an item name is an “article name”, and purchase is “selection of an entry”, by the same control as that for the representation of a catch phrase for a product, a representation of the entry of the article that makes each user interested in the article is generated, based on the accumulated data, for each device type that the user uses.

An aspect of the controller 10 has been descried above as an exemplary embodiment. However, the disclosed form of the controller 10 is an example, and the form of the controller 10 is not limited to the exemplary embodiment described above. Various changes or improvements may be made to exemplary embodiments without departing from the scope of the present disclosure, and an exemplary embodiment to which the change or improvement is made is also included in the disclosed technical scope. For example, the order of the control process illustrated in FIG. 7 may be changed without departing from the scope of the present disclosure.

Furthermore, in the present disclosure, for example, a form in which a control process is implemented by software has been described. However, a process equivalent to the flowchart illustrated in FIG. 7 may be implemented on an application specific integrated circuit (ASIC), a field programmable gate array (FPGA), or a programmable logic device (PLD) and processed by hardware. In this case, the speed of the process is increased compared to the case where the control process is implemented by software.

As described above, the CPU 21 of the controller 10 may be replaced with a dedicated processor specialized for specific processing such as ASIC, FPGA, PLD, a graphics processing unit (GPU), or a floating-point unit (FPU).

Furthermore, the processing of the controller 10 is not necessarily implemented by a single CPU 21. The processing of the controller 10 may be performed by a combination of two or more processors of the same type or different types, such as a plurality of CPUs 21 or a combination of the CPU 21 and the FPGA. Furthermore, the processing of the controller 10 may be implemented by cooperation of a processor that is located outside the housing of the controller 10 at a place physically away from the controller 10.

In an exemplary embodiment, an example in which the control program is stored in the ROM 22 of the controller 10 has been described. However, the control program is not necessarily stored in the ROM 22. The control program according to the present disclosure may be recorded in a recording medium readable by the computer 20 and provided. For example, the control program may be recorded on an optical disc such as a compact disk-read only memory (CD-ROM) or a digital versatile disk-read only memory (DVD-ROM) and provided. Furthermore, the control program may be recorded on a portable semiconductor memory such as a universal serial bus (USB) memory or a memory card and provided. The ROM 22, the nonvolatile memory 24, the CD-ROM, the DVD-ROM, the USB, and the memory card are examples of a non-transitory recording medium.

Furthermore, the controller 10 may download the control program from an external device through the communication unit 27, and the downloaded control program may be stored into, for example, the nonvolatile memory 24. In this case, the CPU 21 of the controller 10 reads the control program that has been downloaded from the external device and performs the control process.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A controller comprising:
a processor configured to
receive an attribute of a device that a user uses, and
control, in accordance with the attribute of the device, a representation of association text such that, by selecting a representation of association text out of a plurality of representations of association text and displaying the selected representation of association text, motivation of the user of a behavior performed for an object displayed in a display region of the device is increased, the association text being associated with the object displayed in the display region of the device.

2. The controller according to claim 1,
wherein the processor is configured to
estimate, for each attribute of the device, a target representation of the association text for the object displayed on the device, in accordance with accumulated data in which user information of the user who uses the device, device information including the attribute of the device, a behavior history of a behavior performed by the user for the object displayed in the display region of the device, and item information regarding the object and including description text describing the object displayed in the display region of the device and the association text associated with the description text are associated with one another, such that, by selecting the representation of association text out of the plurality of representations of association text and displaying the selected representation of association text, the motivation of the user of the behavior performed for the object displayed in the display region of the device is increased, and
perform control such that the representation of the association text generated using a generation model that receives entries obtained from the user information, the device information, and the item information as inputs and displayed in the display region of the device gets close to the target representation corresponding to the attribute of the device.

3. The controller according to claim 2,
wherein the processor is configured to
estimate, as the target representation of the association text, a target number of characters for each attribute of the device, the target number of characters being the number of characters of the association text associated with the object for a case where the user has performed a behavior indicating that the user has paid attention to the object, and
control the number of characters of the association text generated using the generation model for the object displayed in the display region of the device to get close to the target number of characters of the association text corresponding to the attribute of the device.

4. The controller according to claim 2,
wherein the behavior history includes positional information of the association text in the display region of the device in the case where the user has performed the behavior for the object, and
wherein the processor is configured to
estimate, as the target representation of the association text, a target position for each attribute of the device, the target position being a position of the association text in the display region of the device for a case where the user has performed a behavior indicating that the user has paid attention to the object, and
control the position of the association text generated using the generation model for the object displayed in the display region of the device to be arranged at the target position of the association text corresponding to the attribute of the device.

5. The controller according to claim 2,
wherein the processor is configured to
estimate, as the target representation of the association text, a target style for each attribute of the device, the target style being a style of the association text associated with the object for a case where the user has performed a behavior indicating that the user has paid attention to the object, and
control the style of the association text generated using the generation model for the object displayed in the display region of the device to get close to the target style of the association text corresponding to the attribute of the device.

6. The controller according to claim 5, wherein the processor is configured to estimate the target style of the association text for each attribute of the device in accordance with a similarity between the description text for the object for the case where the user has performed the behavior indicating that the user has paid attention to the object and the association text associated with the description text.

7. The controller according to claim 5, wherein the processor is configured to estimate the target style of the association text for each attribute of the device, by performing clustering of the association text for the object for the case where the user has performed the behavior indicating that the user has paid attention to the object.

8. The controller according to claim 5,
wherein the processor is configured to, in a case where the association text for the object displayed in the display region of the device includes a plurality of sentences of different styles, control an order in which the sentences of the different styles are arranged in the display region of the device.

9. The controller according to claim 6,
wherein the processor is configured to, in a case where the association text for the object displayed in the display region of the device includes a plurality of sentences of different styles, control an order in which the sentences of the different styles are arranged in the display region of the device.

10. The controller according to claim 7,
wherein the processor is configured to, in a case where the association text for the object displayed in the display region of the device includes a plurality of sentences of different styles, control an order in which the sentences of the different styles are arranged in the display region of the device.

11. The controller according to claim 2,
wherein the behavior history includes a behavior time regarding a behavior of the user, the behavior time being a time that has passed since display of the association text for the object in the display region of the device, and
wherein the processor is configured to
estimate, based on the behavior time, a device behavior time for a case where the user has performed the behavior indicating that the user has paid attention to the object, for each attribute of the device, and
perform control for generating, using the generation model, the association text corresponding to a behavioral tendency of the user represented by the device behavior time corresponding to the attribute of the device.

12. The controller according to claim 11, wherein the processor is configured to perform control such that the association text representing a difference between the object displayed in the display region of the device and a comparative object to be compared with the object is generated in accordance with an increase of the device behavior time.

13. The controller according to claim 2, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

14. The controller according to claim 3, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

15. The controller according to claim 4, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

16. The controller according to claim 5, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

17. The controller according to claim 6, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

18. The controller according to claim 7, wherein the processor is configured to generate the association text using the generation model such that a degree of influence of a specific part of a character string representing content of a specific entry in the item information on generation of the association text using the generation model is higher than a degree of influence of a different part that is different from the specific part of the character string representing the content of the specific entry on generation of the association text using the generation model.

19. The controller according to claim 13,
wherein the processor is configured to
extract, from the content of the specific entry, a character string not included in content of the specific entry corresponding to a comparative object to be compared with the object displayed in the display region of the device, and
apply weighting to a vector representing the extracted character string such that the degree of influence of the vector representing the extracted character string on generation of the association text using the generation model is higher than the degree of influence of a vector representing a character string not extracted from the content of the specific entry on generation of the association text using the generation model, and thus generate the association text using the generation model.

20. A non-transitory computer readable medium storing a program causing a computer to execute a process for control, the process comprising:
receiving an attribute of a device that a user uses, and
controlling, in accordance with the attribute of the device, a representation of association text such that, by selecting a representation of association text out of a plurality of representations of association text and displaying the selected representation of association text, motivation of the user of a behavior performed for an object displayed in a display region of the device is increased, the association text being associated with the object displayed in the display region of the device.
